(19) United States
(12) Patent Application Publication
(10) Pub. No.: US 2021/0147593 A1
(43) Pub. Date: May 20, 2021

(54) FLUORO ACRYLATE AND METHODS MAKING AND USING THE SAME

(71) Applicant: Madico, Inc., Pinellas Park, FL (US)

(72) Inventors: Philip Canale, Pinellas Park, FL (US); Marina Temchenko, Pinellas Park, FL (US); Barbara Heck, Pinellas Park, FL (US)

(21) Appl. No.: 17/100,130

(22) Filed: Nov. 20, 2020

Related U.S. Application Data
(60) Provisional application No. 62/938,035, filed on Nov. 20, 2019.

(51) Int. Cl. C08F 214/24; C08F 214/26; C08F 214/28; C08F 220/06; C08F 220/36; C08F 220/22; C08F 226/02; C08F 236/20; C08F 2/38

(52) U.S. Cl. CPC C08F 214/247; C08F 214/267; C08F 214/287; C08F 220/06; C08F 2/38; C08F 220/22; C08F 226/02; C08F 236/20; C08F 220/36

(57) ABSTRACT

A number of variations may include a method including modifying fluorocopolymer polyols, diols, and related copolymers to make polymerizable materials through polymerizable unsaturation. A number of variations may include products, for example but not limited to coatings, films or painting including modifying fluorocopolymer polyols, diols, and related copolymers.

### CROSS-REFERENCE TO RELATED APPLICATIONS

This application claims the benefit of U.S. Provisional Application No. 62/938,035, filed Nov. 20, 2019.

### TECHNICAL FIELD

The field to which the disclosure generally relates to includes acrylate-functional fluoropolymers and methods of making and using the same.

### BACKGROUND

Polymers may be made to include functional units for cross linking and may be use in coatings.

### SUMMARY OF ILLUSTRATIVE VARIATIONS

A number of variations may include a method including modifying fluorocopolymer polyol, diols, and related copolymers to make polymerizable materials through polymerizable unsaturation. A number of variations may include methods using or products including a fluorocopolymer polyol comprising at least one of (a) structural units primarily derived from at least one of tetrafluoroethylene, triflouroethylene, vinylidiene fluoride, or trifluorochloroethylene, but may be also derived from other fluoromonomers such as at least one of hexafluoropropylene, perfluoropropylvinylether, or perfluoromethylvinylether are among some of the other monomers available, (b) structural units derived from a nonaromatic vinyl ester monomer free from hydroxyl groups and carboxyl groups, (c) structural units derived from at least monomer units containing a cycloaliphatic pendant group, for example but not limited to vinylcylohexane or vinylcycloheptane, (d) structural units derived from at least one vinylether monomer such as methylvinylether, ethylvinylether, butylvinylether, or cyclohexyl vinyl ether, (e) structural units derived from a hydroxyl-containing vinyl monomer free from aromatic groups and carboxyl groups, (f) structural units derived from a monomer having an aromatic group and being free from hydroxyl groups and carboxyl groups, (g) structural units derived from a carboxyl-containing monomer free from hydroxyl groups and aromatic groups, or (h) structural units derived from other monomers in amounts of 10 to 60 mole. The hydroxy functional fluorocopolymer may be a curable one which is compatible with other components of coating compositions and can give coating films excellent in weather resistance and stain resistance when combined with standard hydroxyl crosslinking agents such as isocyanates. The hydroxyl functionalities may be further reacted with functionalities creating reactive vinyl or vinyl acrylate pendent groups.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### DETAILED DESCRIPTION OF ILLUSTRATIVE VARIATIONS

The following description of the variations is merely illustrative in nature and is in no way intended to limit the scope of the invention, its application, or uses.

A number of variations may include a method including modifying fluorocopolymer polyol, diols, and related copolymers to make polymerizable materials through polymerizable unsaturation. A number of variations may include methods using or products including a fluorocopolymer polyol comprising at least one of (a) structural units primarily derived from at least one of tetrafluoroethylene, triflouroethylene, vinylidiene fluoride, or trifluorochloroethylene, but may be also derived from other fluoromonomers such as at least one of hexafluoropropylene, perfluoropropylvinylether, or perfluoromethylvinylether are among some of the other monomers available, (b) structural units derived from a nonaromatic vinyl ester monomer free from hydroxyl groups and carboxyl groups, (c) structural units derived from at least monomer units containing a cycloaliphatic pendant group, for example but not limited to vinylcylohexane or vinylcycloheptane, (d) structural units derived from at least one vinylether monomer such as methylvinylether, ethylvinylether, butylvinylether, or cyclohexyl vinyl ether, (e) structural units derived from a hydroxyl-containing vinyl monomer free from aromatic groups and carboxyl groups, (f) structural units derived from a monomer having an aromatic group and being free from hydroxyl groups and carboxyl groups, (g) structural units derived from a carboxyl-containing monomer free from hydroxyl groups and aromatic groups, or (h) structural units derived from other monomers in amounts of 10 to 60 mole. The hydroxy functional fluorocopolymer may be a curable one which is compatible with other components of coating compositions and can give coating films excellent in weather resistance and stain resistance when combined with standard hydroxyl crosslinking agents such as isocyanates. The hydroxyl functionalities may be further reacted with functionalities creating reactive vinyl or vinyl acrylate pendent groups. Thus, the fluoropolymer materials normally polymerized with isocyanates or other hydroxyl crosslinking agents in use of high performance weatherable coatings will become polymerizable through these unsaturated polymerizable chemical moieties. In a number of variations the fluorocopolymer polyol, diols, and related copolymers may be used in top coatings for windows and protective films for exterior applications. As used herein the terms weatherable and weatherability refer to Weatherability 5-10 years as measured by changes in haze value (Astm D1003), color change (ASTM D2244) gloss (ASTM D2457, ASTM D523), light transmittance (Astm D1003), adhesion to substrate (ASTM D3359), Taber abrasion (ASTM D4060), The term hardness as used herein refers to Taber abrasion test, which is a test used for scratch resistance (ASTM 04060), here ΔHaze is measured before and after the abrasion, and the aim here is to have ΔHaze <4. Hardness is determining property for the scratch resistance. As used there in the term superior weathering capabilities refers to more than 5 years of outside exposure without significant degradation of desired properties. In our applications it is clarity or low haze (ΔHaze <4), color (ΔE<3), and adhesion to substrate. The fluorinated polymer made as described herein and coatings produced from the same may have superior properties than UV-curable coatings currently known.

In order to produce a coating that has good weathering and corrosion protection, yet, have the capability of being polymerized or cured through unsaturation has been produced in one instance by combining a chlorotrifluoroethylene/vinyl ether alternating copolymer, tripolymer, or terpolymer with 2-Isocyanatoethyl acrylate wherein the Chlorotrifluoroethylene/vinylether terpolymer has the general structure:

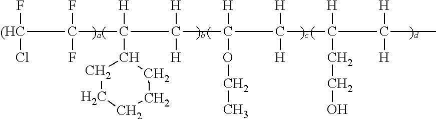

The propose reaction to functionalize this polymer is given in the reaction scheme:

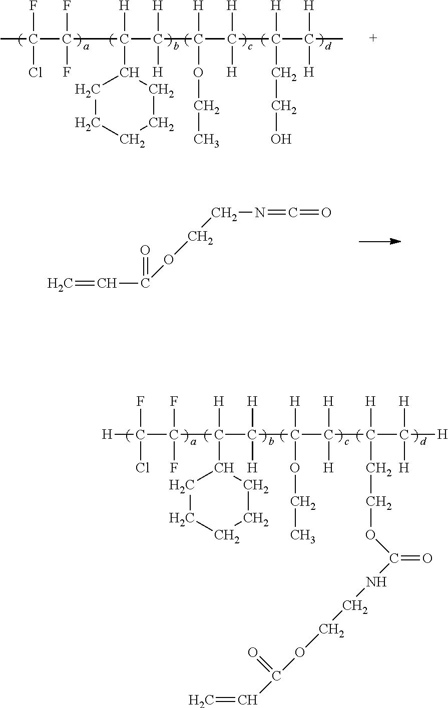

Thus, in this scheme, the general reaction scheme is represented by:

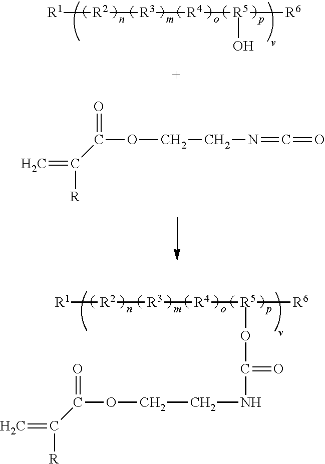

where:
R² can be from any fluorine containing monomer which may enhance weatherability such as trifluorochloroethylene, tetrafluoroethylene, hexafluoropropylene, perfluoromethylvinylether, Perfluoropropylvinylether, vinylidene fluoride, vinylfluoride, or a perfluorocycloalkene. R³, R⁴, and/or R⁵ monomer repeat units, if included may be chosen from various monomer groups these groups vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or any other such common monomer vinyl repeating group used in vinyl/alkene addition type polymerizations. Of particular interests in these groups of monomers are those such as the hydroxyalkyl methacrylate or hydroxyl alkyl acrylate, vinyl ethers or vinyl acetates which are hydroxyl functional or later may be easily converted into a hydroxyl functionality. These materials are more completely described in U.S. Pat. No. 8,785,556B2, U.S. Pat. No. 7,579,056 B2, JP 1296394, WO2015129923A1, and US patent application 20170009000. Examples of some of the commercially available hydroxyl functional cross-linkable fluoropolymers\copolymers for use in functionalization by isocyanates, isocyanate acrylates or diisocyanates and hydroxyl functional acrylates include LUMIFLON (Asahi Glass Co., Ltd., Tokyo, Japan), CEFRAL COAT (Central Glass Co., Ltd., Tokyo, Japan), ZEFFLE (Daikin Industries, Ltd., Osaka, Japan) and FLUONATE (DIC Corporation, Tokyo, Japan).

R¹ and R⁶ are from a group of initiators, chain transfer, chain termination, or coupling groups that are known for those skilled in the technology of polymerization. These may be put in on purpose to enhance chain transfer, termination or coupling to enhance stability or end groups for enhanced functionality or stability, or to modify molecular weight and/or molecular weight distribution.

In addition, functionality with unsaturation can be built into the hydroxyl functionality not only using 2-isocyanatoethyl acrylate as shown the above schemes but also using other isocyanate functional acrylates such as 2-methacryloyloxyethyl isocyanate, 2-isocyanatoethyl methacrylate, 1-isocyanatomethyl methacrylate, 1-isocyanatomethyl acrylate, or inclusively a structure having the general formula:

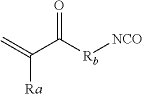

where R₁ can be hydrogen or fluorine, or a group including carbon. Where Rₐ and R_{b} in this instance can come from the aliphatic moieties such methyl, ethyl, propyl, butyl, pentyl, hexyl, heptyl, octyl, hexyl, and isomers thereof. R₁ and R₂ can also be from the group of ethylene oxide, propylene oxide, butylene oxide, pentyl oxide, hexyl oxide, and isomers thereof. Rₐ and R_{b} can also be from the group of fluorinated or partial fluorinated isomers of the afore mentioned moieties. The partially or fully fluorinated versions of all these moieties would also be claimed as these give superior weather and stain resistance at the cost of expense. In these reactions tertiary amine, organotin, organozinc, and organobismuth among others skilled in the art of urethanes may be used to catalyze the reaction of the fluorocopolymer with the isocyanate acrylate. Stabilizers such as butylated hydroxy toluene are also usually added to stabilize the unsaturation to prevent premature unsaturation reaction.

In addition, one can use a difunctional isocyanate acrylates of the general formula:

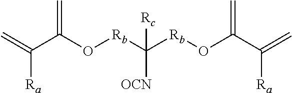

where Rₐ can be hydrogen or fluorine or come from the class of aliphatic moieties such methyl, ethyl, propyl, butyl, pentyl, hexyl, heptyl, octyl, hexyl, and isomers thereof. R_{b} and R_{c} can also be from the group of ethylene oxide, propylene oxide, butylene oxide, pentyl oxide, hexyl oxide, and isomers thereof. Rₐ, R_{b}, and R_{c} can also be from the group of fluorinated or partial fluorinated isomers of the afore mentioned moieties. The partially or fully fluorinated versions of all these moieties would also be claimed as these give superior weather, dielectric properties, and stain resistance at the cost of expense.

In order to increase the crosslink density of the acrylic functionalized copolymer created in applications requiring materials with higher hardness, modulus, or just a higher glass transition temperature mixtures with other acrylates or methacrylates can be made. These (meth)acrylate functional materials are usually higher crosslink density materials. For those skilled in the art, among these materials include but are not limited to are dipentaerythritol pentacrylate, hexanediol diacrylate, tricyclodecane dimethanol diacrylate, tricyclodecane dimethanol dimethacrylate, trimethylolpropane trimethacrylate, trimethylolpropane ethoxy triacrylate, trimethylolpropane ethoxy trimethacrylate, trimethylolpropane ethoxy triacrylate, ditrimethylolpropane tetraacrylate, ditrimethylolpropane tetramethacrylate, epoxy acrylates, or epoxy methacrylates, isocyanurate triacrylate, isocyanurate trimethacrylate, pentaerythritol tetramethacrylate, pentaerythritol tetraacrylate, propoxylated glycerol triacrylate, propoxylated glycerol trimethacrylate, ethoxylated pentaerythritol tetraacrylate, ethoxylated pentaerythritol tetramethacrylate, melamine triacrylate, melamine trimethacrylate, di pentaerythritol hexaacrylate, and di pentaerythritol hexamethacrylate among others. In addition, there is a host of proprietary urethane and polyester acrylates and methacrylates of high functionality that may be utilized.

In formulating for those skilled in the art are other functional acrylates based on silicone or fluorosilicon to incorporate slip and stain resistance. Some (meth)acrylates based on phosphorous or acrylic or methacrylic acid functionalities increase adhesion. Acrylates with long chains may be used to enhance flexibility, wetting or low temperature properties. In addition, fluorinated versions of (meth)acrylates will increase weatherability, dielectric properties, and stain resistance. Silicone and fluorosilicone acrylates are used to reduce the coefficient of friction and/or form a hydrophobic surface for water repellency. Many other specialty (meth)acrylates may be used to produce other properties.

In formulating the materials for use such as in solutions or liquid coatings, for those skilled in the art, additives may be used. These additives include but are not limited to UV absorbers, HALS, fillers such as nanosilica, nanozinc, nanosilver, nanoalumina, antimicrobials, antifungals, pigments, acid absorbers such as cycloaliphatic epoxies, slip agents, or thermal stabilizers such as BHT to prevent premature polymerization among others.

The curing or polymerization of these materials can take place by several means to produce a solid coating. Normal means for the polymerization of acrylates include, Michael addition, thermally initiated free radical polymerization, redox initiated thermal polymerization, and UV initiator polymerization. Thermally initiated free radical polymerization usually uses peroxides as well as diazo compounds to produce free radicals to initiate polymerizations. Redox initiated thermal polymerizations utilize peroxides and a reducing agent to produce free radicals when mixed (see U.S. Pat. Nos. 4,536,546A, 5,112,691A and 6,730,411B1 patents and citations). Michael addition can also be utilized by mixing with an amine or mercaptan. Among the most utilized however are free radical polymerizations utilizing free radical “UV” electromagnetic spectrum (UV and visible) initiators. These initiators can be type I (typical types are benzyl ketal, hydroxyacetophenones, aminoacetophenones, or phosphine oxides) or type II photoinitators (typical types are benzyl formates, benzophenones, substituted benzophenones, or thioxanthones). Type II initators can typically use an amine synergist to promote cure and minimize oxygen inhibition side reactions. In addition, sensitizers such as isopropylthioxanthone can be utilized to extend the electromagnetic spectrum sensitivity of the reaction.

Formulations as described can be used as coatings on plastics (polymeric material), as well as metals and glass especially those applications where exposure to exterior weathering is prevalent. Polymeric materials may include, for example but not limited to, PET, polycarbonate, Acrylate, and TPU.

The following description of variants is only illustrative of components, elements, acts, product and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a method comprising reacting:

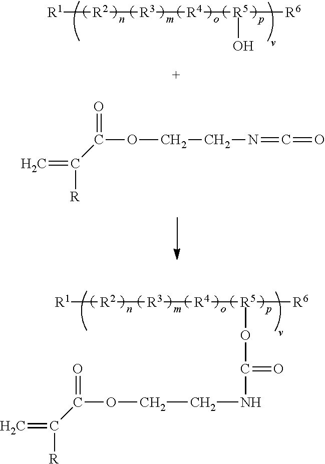

where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

Variation 2 may include a method as set forth in Variation 1 wherein R is methyl, ethyl, propyl, butyl, pentyl, hexyl, heptyl, octyl, hexyl, and isomers thereof.

Variation 3 may include a method as set forth in Variation 1 wherein R is an acrylic acid group.

Variation 4 may include a method as set forth in Variation 1 wherein R is a group of ethylene oxide, propylene oxide, butylene oxide, pentyl oxide, hexyl oxide, and isomers thereof.

Variation 5 may include a method as set forth in any of Variations 1-4 wherein R² is a trifluorochloroethylene, tetrafluoroethylene, hexafluoropropylene, perfluoromethylvinylether group.

Variation 6 may include a method as set forth in Variations 1-5 wherein each of at least one of R³, R⁴, and R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group.

Variation 7 may include a method as set forth in Variations 1-6 wherein R³, R⁴, and R⁵ are different monomer repeat units.

Variation 8 may include a method comprising reacting

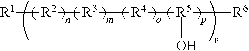

with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula:

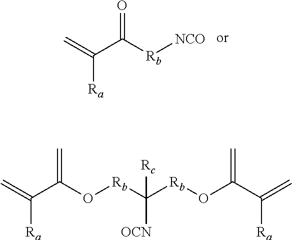

where R² can be from a fluorine containing monomer,
R¹ and R⁶ are from a group of initiators, chain transfer, chain termination, or coupling groups; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein Rₐ is a group of aliphatic or fluorinated aliphatic.

Variation 9 may include a method as set forth in Variation 8 where Rₐ, and R_{b} is an aliphatic moiety.

Variation 10 may include a method as set forth in Variation 8 where Rₐ and R_{b} is methyl, ethyl, propyl, butyl, pentyl, hexyl, heptyl, octyl, hexyl, and isomers thereof.

Variation 11 may include a method as set forth in Variation 8 where Rₐ and Rₐ is a group of ethylene oxide, propylene oxide, butylene oxide, pentyl oxide, hexyl oxide, and isomers thereof.

Variation 12 may include a method as set forth in Variation 8 where Rₐ and R_{b} is group of fluorinated or partial fluorinated isomers.

Variation 13 may include a method as set forth in Variation 8 wherein the reacting produces a polymeric material, and further comprising curing the polymeric material to produce a solid coating.

Variation 14 may include a method as set forth in Variation 8 where R² is trifluorochloroethylene, tetrafluoroethylene, hexafluoropropylene, perfluoromethylvinylether, Perfluoropropylvinylether, vinylidene fluoride, vinylfluoride, or a perfluorocycloalkene.

Variation 15 may include a method as set forth in any of Variations 8-14 wherein at least one of R³, R⁴, or R⁵ is a group of vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl.

Variation 16 may include a method as set forth in any of Variations 8-14 wherein R³, R⁴, or R⁵ are a group of vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl.

Variation 17 may include a method as set forth in any of Variations 8-16 wherein Rₐ is hydrogen or fluorine, or a group including carbon.

Variation 18 may include a method comprising reacting

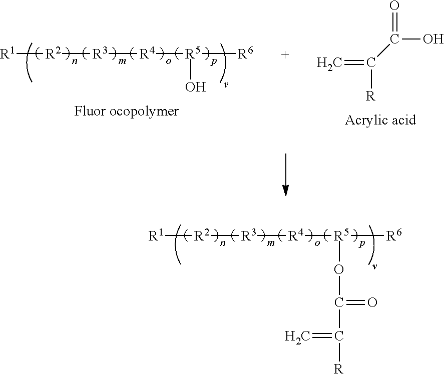

where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

Variation 19 may include a method as set forth in Variation 18 wherein R is methyl, ethyl, propyl, butyl, pentyl, hexyl, heptyl, octyl, hexyl, and isomers thereof.

Variation 20 may include a method as set forth in Variation 18 wherein R is an acrylic acid group.

Variation 21 may include a method as set forth in Variation 18 wherein R is a group of ethylene oxide, propylene oxide, butylene oxide, pentyl oxide, hexyl oxide, and isomers thereof.

Variation 22 may include a method as set forth in Variation 18 wherein R² is a trifluorochloroethylene, tetrafluoroethylene, hexafluoropropylene, perfluoromethylvinylether group.

Variation 23 may include a coating solution comprising

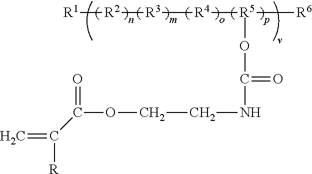

where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

Variation 24 may include a coating solution comprising the product of reacting

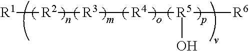

with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula:

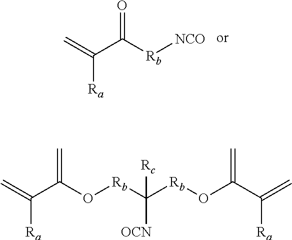

where R² can be from any fluorine containing monomer which may enhance weatherability such as trifluorochloroethylene, tetrafluoroethylene, hexafluoropropylene, perfluoromethylvinylether, Perfluoropropylvinylether, vinylidene fluoride, vinylfluoride, or a perfluorocycloalkene. R³, R⁴, and/or R⁵ monomer repeat units, if included may be chosen from various monomer groups these groups vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl;
R¹ and R⁶ are from a group of initiators, chain transfer, chain termination, or coupling groups;
Rₐ is hydrogen or fluorine, or a group including carbon.

Variation 25 may include a substrate having a solid coating thereon produced by curing

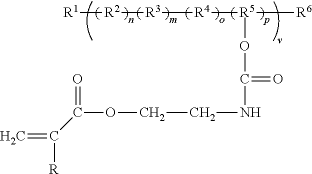

where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

Variation 26 may include a substrate having a solid coating thereon produced by curing

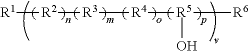

with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula:

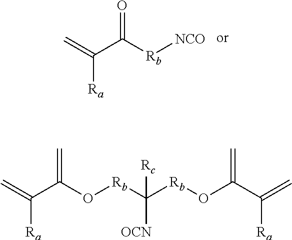

where R² can be from any fluorine containing monomer which may enhance weatherability such as trifluorochloroethylene, tetrafluoroethylene, hexafluoropropylene, perfluoromethylvinylether, Perfluoropropylvinylether, vinylidene fluoride, vinylfluoride, or a perfluorocycloalkene. R³, R⁴, and/or R⁵ monomer repeat units, if included may be chosen from various monomer groups these groups vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl;
R¹ and R⁶ are from a group of initiators, chain transfer, chain termination, or coupling groups;
Rₐ is hydrogen or fluorine, or a group including carbon.

The above description of select variations within the scope of the invention is merely illustrative in nature and, thus, variations or variants thereof are not to be regarded as a departure from the spirit and scope of the invention.

What is claimed is:

1. A method comprising reacting: 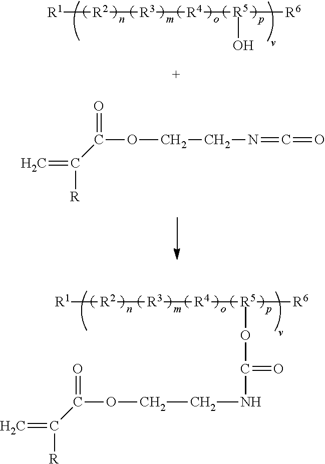
where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

2. A method as set forth in claim 1 wherein R is methyl, ethyl, propyl, butyl, pentyl, hexyl, heptyl, octyl, hexyl, and isomers thereof.

3. A method as set forth in claim 1 wherein R is a group of ethylene oxide, propylene oxide, butylene oxide, pentyl oxide, hexyl oxide, and isomers thereof.

4. A method as set forth in claim 1 wherein R² is a trifluorochloroethylene, tetrafluoroethylene, hexafluoropropylene, perfluoromethylvinylether group.

5. A method as set forth in claim 1 wherein each of at least one of R³, R⁴, and R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group.

6. A method comprising reacting 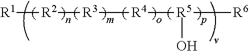
with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula: 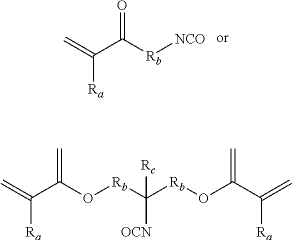
where R² can be from a fluorine containing monomer,
R¹ and R⁶ are from a group of initiators, chain transfer, chain termination, or coupling groups; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

7. A method as set forth in claim 6 where Rₐ and R_{b} is an aliphatic moiety.

8. A method as set forth in claim 7 wherein Rₐ and R_{b} is methyl, ethyl, propyl, butyl, pentyl, hexyl, heptyl, octyl, hexyl, and isomers thereof.

9. A method as set forth in claim 6 where Rₐ and R_{b} is a group of ethylene oxide, propylene oxide, butylene oxide, pentyl oxide, hexyl oxide, and isomers thereof.

10. A method as set forth in claim 6 where Rₐ and R_{b} is group of fluorinated or partial fluorinated isomers.

11. A method as set forth in claim 6 wherein the reacting produces a polymeric material, and further comprising curing the polymeric material to produce a solid coating.

12. A method as set forth in claim 6 wherein R² is trifluorochloroethylene, tetrafluoroethylene, hexafluoropropylene, perfluoromethylvinylether, Perfluoropropylvinylether, vinylidene fluoride, vinylfluoride, or a perfluorocycloalkene.

13. A method as set forth in claim 6 where at least one of R³, R⁴, or R⁵ is a group of vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl.

14. A method as set forth in claim 6 where R³, R⁴, or R⁵ are a group of vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl.

15. A method as set forth in claim 6 wherein Rₐ is hydrogen or fluorine, or a group including carbon.

16. A coating solution comprising 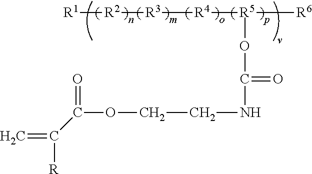
where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

17. A coating solution comprising the product of reacting 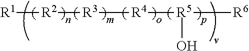
with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula: 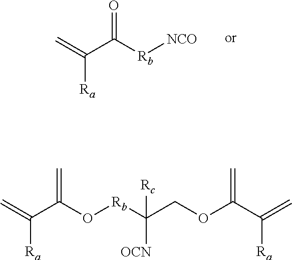
where R² can be from any fluorine containing monomer which may enhance weatherability such as trifluorochloroethylene, tetrafluoroethylene, hexafluoropropylene, perfluoromethylvinylether, Perfluoropropylvinylether, vinylidene fluoride, vinylfluoride, or a perfluorocycloalkene. R³, R⁴, and/or R⁵ monomer repeat units, if included may be chosen from various monomer groups these groups vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl;
R¹ and R⁶ are from a group of initiators, chain transfer, chain termination, or coupling groups;
Rₐ is hydrogen or fluorine, or a group including carbon.

18. A substrate having a solid coating thereon produced by curing 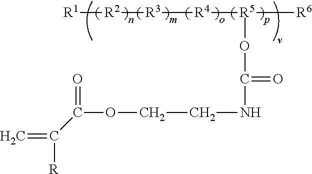
where, R² comprises a fluorine containing monomer; at least one of R³, R⁴, or R⁵ is a monomer repeat units comprising a group including vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl repeating group; each of R¹ and R⁶ includes a initiator, chain transfer, chain termination, or coupling, and wherein R is a group of aliphatic or fluorinated aliphatic.

19. A substrate having a solid coating thereon produced by curing 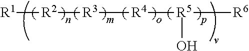
with at least one of:
2-methacryloyloxyethyl isocyanate, 2-isocyanatoethyl methacrylate, 1-isocyanatomethyl methacrylate, 1-isocyanatomethyl acrylate, or inclusively a structure having the general formula: 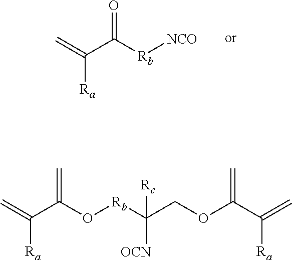
where R² can be from any fluorine containing monomer which may enhance weatherability such as trifluorochloroethylene, tetrafluoroethylene, hexafluoropropylene, perfluoromethylvinylether, Perfluoropropylvinylether, vinylidene fluoride, vinylfluoride, or a perfluorocycloalkene. R³, R⁴, and/or R⁵ monomer repeat units, if included may be chosen from various monomer groups these groups vinyl acetate, methyl vinyl ether, ethyl vinyl ether, butyl vinyl ether, ethylene, propylene, methyl acrylate, ethyl acrylate butyl acrylate, hexyl acrylate, methyl methacrylate, ethyl methacrylate, propyl methacrylate, butyl methacrylate, vinyl cyclohexane, acrylic acid, acrylonitrile, acrylamide, glycidyl methacrylate or acrylate, or a monomer vinyl;
R¹ and R⁶ are from a group of initiators, chain transfer, chain termination, or coupling groups;
Rₐ is hydrogen or fluorine, or a group including carbon.
